(19) United States
(12) Patent Application Publication
(10) Pub. No.: US 2026/0194838 A1
(43) Pub. Date: Jul. 9, 2026

(54) DEVELOPING DEVICE AND IMAGE FORMING APPARATUS

(71) Applicant: FUJIFILM Business Innovation Corp., Tokyo (JP)

(72) Inventors: Wataru SUZUKI, Kanagawa (JP); Yasuki TANAKA, Kanagawa (JP); Hirokazu MUKAI, Kanagawa (JP)

(73) Assignee: FUJIFILM Business Innovation Corp., Tokyo (JP)

(21) Appl. No.: 19/294,199

(22) Filed: Aug. 7, 2025

(30) Foreign Application Priority Data
Jan. 7, 2025 (JP) 2025-002210

(51) Int. Cl. G03G 15/08

(52) U.S. Cl. CPC G03G 15/086; G03G 15/0853; G03G 15/0889; G03G 15/0891; G03G 2215/0607; G03G 2215/0833; G03G 2215/0888

(57) ABSTRACT

A developing device includes: a developing container that accommodates a developer; an agitating and transport member that includes a rotation shaft and a helical blade formed in a helical shape in an axial direction with respect to the rotation shaft and that transports the developer in the developing container while agitating the developer; a transport path that accommodates the agitating and transport member and includes a high-speed transport region in which the developer is transported at a high speed and a low-speed transport region that is arranged on a downstream side of the high-speed transport region in a transport direction of the developer and in which the developer is transported at a lower speed than in the high-speed transport region; and a volume detection unit that is installed within a range set in advance from a switching portion that switches from the high-speed transport region to the low-speed transport region to an upstream side in the transport direction or in the low-speed transport region and that detects a volume of the developer in the transport path.

### CROSS-REFERENCE TO RELATED APPLICATIONS

This application is based on and claims priority under 35 USC 119 from Japanese Patent Application No. 2025-002210 filed Jan. 7, 2025.

### BACKGROUND

### (i) Technical Field

The present disclosure relates to a developing device and an image forming apparatus.

### (ii) Related Art

JP2018-159940A discloses a developing device including a developer detection unit that detects a developer accommodated in a developer accommodation portion and a sheet member that is arranged in the developer accommodation portion to be rotatable about a rotation shaft. The sheet member includes a first developer transport means that transports the developer in a direction toward one end portion of the rotation shaft in an axial direction and a second developer transport means that transports the developer in a direction toward the other end portion of the rotation shaft in the axial direction. The developer detection unit is arranged on an inner wall of the developer accommodation portion corresponding to the one end portion.

JP2012-58603A discloses a developing device including a transport means that transports a developer from an agitating unit to a developing unit. The developing unit includes a transport member that is rotated to transport the developer such that the developer is carried on a developer carrier and a developer surface position detection means that detects whether or not a developer surface position of the developer in a transport region in which the developer is transported by the transport member is a predetermined position. The amount of developer transported by the transport means is controlled based on first information that is related to whether or not the developer surface position is the predetermined position and that has been detected by the developer surface position detection means and second information related to the number of rotations of the transport member.

JP2021-092623A discloses a developing device including a developing container, a first agitating and transport member, a second agitating and transport member, a developer supply port, a developer discharge unit, a developer carrier, a control unit, and a volume detection sensor. The developing container has a first transport chamber and a second transport chamber that is arranged in parallel to the first transport chamber with a partition portion interposed therebetween. A magnetic permeability sensor is arranged in the first transport chamber and detects the magnetic permeability of a developer in the first transport chamber, and the control unit estimates a developer volume in the first transport chamber based on an output value of the volume detection sensor and adjusts the amount of developer discharged from the developer discharge unit according to the estimated developer volume.

### SUMMARY

The amount of developer in the developing container varies depending on the amount of developer consumed and the amount of developer supplied. In a case where the amount of developer in the developing container varies, the charge amount of the developer or the amount of developer supplied to a developing roller is unstable, which causes quality degradation such as uneven image density.

Therefore, the amount of developer in the developing container is kept constant by detecting the amount of developer in the developing container using a sensor and by supplying the developer into the developing container or discharging the developer in the developing container, based on the detected amount of developer.

However, in a case where the volume of the developer is detected in the transport path in which the developer is transported while being agitated, the volume varies due to the rotation of the agitating and transport member that transports the developer while agitating the developer, which makes it difficult to accurately detect the amount of developer in the developing container.

Aspects of non-limiting embodiments of the present disclosure relate to a developing device and an image forming apparatus that can improve detection accuracy of an amount of developer in a developing container, as compared to a case where a volume of the developer is detected without changing a transport speed of the developer in a transport path in which the developer is transported while being agitated.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing device including: a developing container that accommodates a developer; an agitating and transport member that includes a rotation shaft and a helical blade formed in a helical shape in an axial direction with respect to the rotation shaft and that transports the developer in the developing container while agitating the developer; a transport path that accommodates the agitating and transport member and includes a high-speed transport region in which the developer is transported at a high speed and a low-speed transport region that is arranged on a downstream side of the high-speed transport region in a transport direction of the developer and in which the developer is transported at a lower speed than in the high-speed transport region; and a volume detection unit that is installed within a range set in advance from a switching portion that switches from the high-speed transport region to the low-speed transport region to an upstream side in the transport direction or in the low-speed transport region and that detects a volume of the developer in the transport path.

### BRIEF DESCRIPTION OF THE DRAWINGS

Exemplary embodiment(s) of the present invention will be described in detail based on the following figures, wherein:

FIG. 1 is a schematic diagram showing a configuration of an image forming apparatus according to an exemplary embodiment of the present disclosure;

FIG. 2 is a transverse cross-sectional view showing a developing device according to the exemplary embodiment of the present disclosure;

FIG. 3 is a longitudinal cross-sectional view showing the developing device according to the exemplary embodiment of the present disclosure;

FIG. 4A is a transverse cross-sectional view showing a developer supply unit that supplies a developer to the developing device according to the exemplary embodiment of the present disclosure; FIG. 4B is a transverse cross-sectional view showing a developer discharge unit of the developing device according to the exemplary embodiment of the present disclosure;

A part (A) in FIG. 5 is a schematic cross-sectional view showing a flow of the developer in a developing container according to the exemplary embodiment of the present disclosure, a part (B) in FIG. 5 is a diagram showing a change in a transport speed of the developer in a second transport path of the developing device, and a part (C) in FIG. 5 is a diagram showing a comparison between filling rates of the developer in the second transport path of the developing device in a case where the amount of developer is large and in a case where the amount of developer is small;

FIG. 6A is a diagram showing the amount of developer in the developing container and a comparison between changes in the volume of the developer at a fixed point in a portion in which the transport speed is high and in a portion where the transport speed is low, FIG. 6B is a diagram showing a relationship between the density and fluidity of the developer, and FIG. 6C is a diagram showing a relationship between the amount of developer in the developing container and an output of a volume detection sensor;

FIGS. 7A to 7C are image diagrams showing the change in the volume of the developer in the second transport path in a state in which the volume detection sensor is installed in a switching portion;

FIG. 8A is a diagram showing comparison between the changes in the volume of the developer in the second transport path in a state in which the amount of developer is large and in a state in which the amount of developer is small; FIG. 8B is a diagram showing an installation range of the volume detection sensor in a longitudinal direction;

FIG. 9 is a diagram showing the installation range of the volume detection sensor and a concentration sensor in a circumferential direction; and

FIGS. 10A to 10C are diagrams showing modification examples of a low-speed transport region according to the exemplary embodiment of the present disclosure.

### DETAILED DESCRIPTION

Next, an exemplary embodiment of the present disclosure will be described in detail with reference to the drawings.

In addition, the drawings used in the following description are all schematic, and a relationship between the dimensions of elements, the proportion of the elements, and the like shown in the drawings are not necessarily matched with the actual relationship and proportion. In addition, the relationships between the dimensions of the elements, the proportions of the elements, and the like are also not necessarily matched with each other in a plurality of drawings. Further, in the plurality of drawings, substantially identical elements are denoted by the identical reference numerals, the elements will be described in the drawing in which the elements first appear, and the description of the elements in the subsequent drawings will be omitted unless particularly necessary.

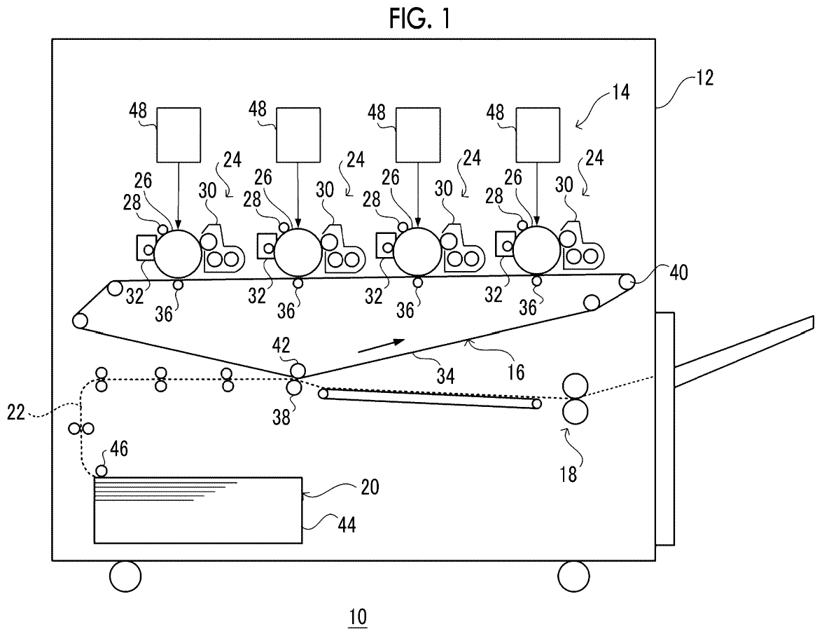

FIG. 1 shows an image forming apparatus 10 used in the exemplary embodiment of the present disclosure. The image forming apparatus 10 includes an image forming apparatus body 12, and an image forming section 14, a transfer device 16, a fixing device 18, and a paper feeding device 20 are arranged in the image forming apparatus body 12. In addition, a transport path 22 for transporting a recording medium, such as paper, is formed in the image forming apparatus body 12.

The image forming section 14 is an electrophotographic type and forms an image on the recording medium. The image forming section 14 includes a plurality of image forming units 24, for example, four image forming units 24. The four image forming units 24 form toner images of different colors such as yellow, magenta, cyan, and black.

The image forming unit 24 has a photoconductor drum 26. The photoconductor drum 26 is an example of an image carrier on which an electrostatic latent image is held and is rotated, with the toner image to be transferred to the recording medium held on an outer peripheral surface. In addition, the image forming unit 24 is provided with a charging device 28 that charges the photoconductor drum 26, a developing device 30 that develops a charged electrostatic latent image with toner, and a cleaning device 32 that cleans the photoconductor drum 26 after transfer. Further, an optical writing device 48 that forms an electrostatic latent image on the charged photoconductor drum 26 is provided.

The transfer device 16 includes an intermediate transfer belt 34. The toner images are primarily transferred from the photoconductor drums 26 onto the intermediate transfer belt 34 by a primary transfer member 36, and the primarily transferred toner images are secondarily transferred onto the recording medium by a secondary transfer member 38.

The intermediate transfer belt 34 is supported by a plurality of support members 40 to be rotatable. In addition, a backup member 42 is provided to face the secondary transfer member 38.

The fixing device 18 fixes the toner images transferred onto the recording medium to the recording medium using, for example, heat and pressure.

The paper feeding device 20 includes an accommodation portion 44 that accommodates the recording media in a stacked state and a delivery member 46 that delivers the recording medium accommodated in the accommodation portion 44 toward the transport path 22.

The recording medium is transported from the paper feeding device 20 to a location between the secondary transfer member 38 and the backup member 42 through the transport path 22, is further transported to the fixing device 18, and is further transported to be discharged outside the image forming apparatus body 12.

In the image forming apparatus 10 configured as described above, the toner images formed on the outer peripheral surfaces of the photoconductor drums 26 are primarily transferred onto the intermediate transfer belt 34, the toner images primarily transferred onto the intermediate transfer belt 34 are secondarily transferred onto the recording medium, and the toner images secondarily transferred onto the recording medium are fixed to the recording medium by the fixing device 18.

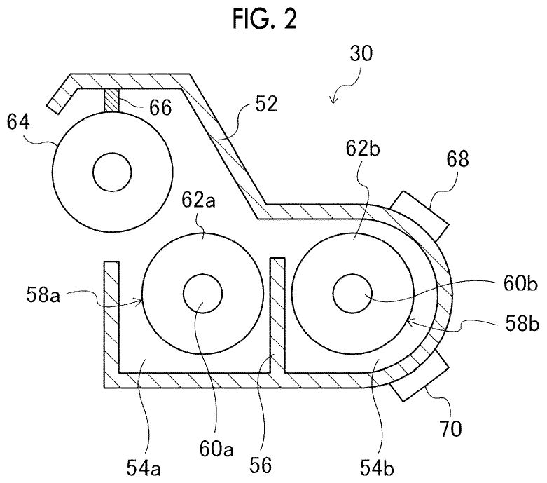

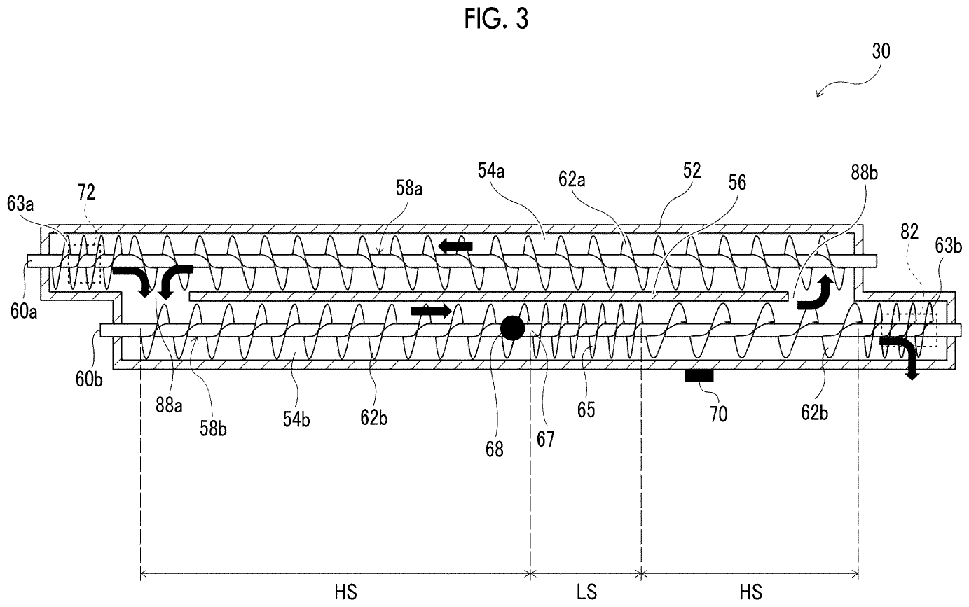

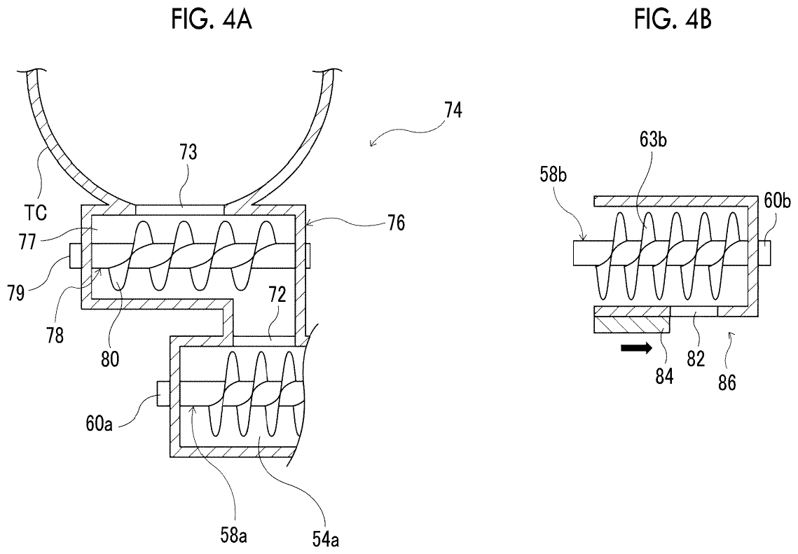

Next, the developing device 30 will be described in detail with reference to FIGS. 2 to 4.

The developing device 30 is a two-component developing device that agitates a developer, which is a two-component developer including toner and a carrier, and charges the toner to perform development.

The developing device 30 has a developing container 52 that accommodates the developer. The developing container 52 includes a first transport path 54a and a second transport path 54b adjacent to the first transport path 54a. The first transport path 54a and the second transport path 54b are formed to extend in a longitudinal direction of the developing container 52 and to be parallel to each other in a horizontal direction. The first transport path 54a and the second transport path 54b are partitioned in a right-left direction by, for example, a partition wall 56 and communicate with each other in end portions.

A developing roller 64 is provided above the first transport path 54a in the developing container 52. The first transport path 54a is configured to supply the developer to the developing roller 64. The developing roller 64 faces the photoconductor drum 26 and is configured to move the toner attached to a magnetic brush formed around the developing roller 64 to the electrostatic latent image formed on the photoconductor drum 26. In addition, a layer thickness regulating member 66 is provided above the developing roller 64 and is configured to regulate a layer thickness of the developer.

A first agitating and transport member 58a that transports the developer in the first transport path 54a while agitating the developer is arranged in the first transport path 54a. A second agitating and transport member 58b that transports the developer in the second transport path 54b while agitating the developer is arranged in the second transport path 54b.

The first agitating and transport member 58a includes a rotation shaft 60a, a helical blade 62a that is formed in a helical shape in an axial direction with respect to the rotation shaft 60a, and a helical blade 63a having a narrower pitch than the helical blade 62a. The helical blade 63a is formed in a helical shape in a direction opposite to the helical blade 62a. The helical blade 63a is provided in an end portion of the first agitating and transport member 58a on the most downstream side and is arranged below a supply port 72 which will be described below.

The second agitating and transport member 58b includes a rotation shaft 60b, a helical blade 62b that is formed in a helical shape in an axial direction with respect to the rotation shaft 60b, a helical blade 65 having a narrower pitch than the helical blade 62b, and a helical blade 63b having a narrower pitch than the helical blade 62b. The helical blades 62b, 65, and 63b are formed in a helical shape in a direction opposite to the helical blade 62a. The helical blade 65 is provided between the helical blades 62b in the second agitating and transport member 58b. In addition, the helical blade 63b is provided in an end portion of the second agitating and transport member 58b on the most downstream side and is arranged above a discharge port 82 which will be described below.

Here, a region, in which the helical blade 62b is arranged, in the second transport path 54b is referred to as a high-speed transport region HS in which the developer is transported at a high speed. In addition, a region, in which the helical blade 65 having a narrower pitch than the helical blade 62b is arranged, in the second transport path 54b is referred to as a low-speed transport region LS in which the developer is transported at a low speed.

That is, the second transport path 54b accommodates the second agitating and transport member 58b and includes the high-speed transport region HS in which the developer is transported at a high speed and the low-speed transport region LS in which the developer is transported at a lower speed than in the high-speed transport region HS.

A volume detection sensor 68 as a volume detection unit that detects the volume of the developer in the second transport path 54b is provided on an outer surface of the developing container 52 in the vicinity of a switching portion 67, in which the high-speed transport region HS switches to the low-speed transport region LS, in the second transport path 54b. The volume detection sensor 68 is provided in a range that is set in advance from the switching portion 67 to the upstream side in the transport direction of the developer or in the low-speed transport region LS. For example, a magnetic permeability sensor or the like can be used as the volume detection sensor 68.

Here, “the range set in advance from the switching portion 67 to the upstream side in the transport direction of the developer” is a region in which the amount of change in the volume measured by the volume detection sensor 68 is large in a state in which the amount of developer in the developing container 52 is large and in a state in which the amount of developer in the developing container 52 is small and can be defined by, for example, the number of pitches of the helical blade 62b on the upstream side of the switching portion 67 with respect to the switching portion 67. Specifically, for example, “within the range set in advance from the switching portion 67 to the upstream side in the transport direction of the developer” is within a range from the switching portion 67 to a position that is upstream by a distance corresponding to three pitches of the helical blade 62b in the high-speed transport region HS. In addition, the pitch of the helical blade 62b is the length of the rotation shaft 60b in the axial direction in a case where the helical blade 62b makes one turn around the rotation shaft 60b.

Further, a concentration sensor 70 as a concentration detection unit that detects the concentration of the developer is provided on an outer surface of the developing container 52 in the high-speed transport region HS on the downstream side of the low-speed transport region LS of the second transport path 54b. For example, a magnetic permeability sensor or the like can be used as the concentration sensor 70.

The supply port 72 for supplying the developer into the developing container 52 is formed in an upper surface of an end portion of the developing container 52 on the most downstream side of the first transport path 54a. A developer supply unit 74 is connected above the supply port 72 in the vertical direction.

The developer supply unit 74 has a replaceable developer cartridge TC that accommodates the developer and a connection portion 76 that connects an opening portion 73 of the developer cartridge TC and the supply port 72. A supply path 77 is formed in the connection portion 76. The supply path 77 is provided with an agitating and transport member 78 that transports the developer supplied from the developer cartridge TC toward the supply port 72 while agitating the developer. The agitating and transport member 78 includes a rotation shaft 79 and a helical blade 80 that is formed in a helical shape around the rotation shaft 79.

A discharge port 82 for discharging the developer in the developing container 52 to the outside is formed in a lower surface of an end portion of the developing container 52 on the most downstream side of the second transport path 54b. The discharge port 82 is provided with an opening and closing portion 84 that can open and close the discharge port 82. The discharge port 82 and the opening and closing portion 84 are used as a developer discharge unit 86.

The supply of the developer by the developer supply unit 74 and the discharge of the developer by the developer discharge unit 86 are performed based on detection values of the volume detection sensor 68 and the concentration sensor 70.

In the above-described configuration, as shown in a part (A) in FIG. 5, the developer is first supplied to the most downstream side of the first transport path 54a by the developer supply unit 74 through the supply port 72. Then, the developer is supplied to the second transport path 54b through a supply unit-side communication portion 88a while being agitated by the first agitating and transport member 58a. Then, the developer is transported to the most downstream side of the second transport path 54b by the second agitating and transport member 58b and is supplied to the first transport path 54a through a discharge unit-side communication portion 88b. Then, the developer is transported to the most downstream side of the first transport path 54a by the first agitating and transport member 58a and circulates between the first transport path 54a and the second transport path 54b. In this case, based on the detection values of the volume detection sensor 68 and the concentration sensor 70, the developer supply unit 74 supplies the developer into the developing container 52 through the supply port 72, and the developer discharge unit 86 discharges an excess amount of the developer circulating between the first transport path 54a and the second transport path 54b to the outside of the developing container 52 through the discharge port 82.

Next, an installation range of the volume detection sensor 68 will be described in detail.

As described above, the volume detection sensor 68 is installed in the range set in advance from the switching portion 67 to the upstream side in the transport direction of the developer or in the low-speed transport region LS, for example, in the range from the switching portion 67 to the position that is upstream by a distance corresponding to three pitches of the helical blade 62b in the high-speed transport region HS, or in the low-speed transport region LS.

A part (B) in FIG. 5 is a diagram showing a change in the transport speed of the developer in the second transport path 54b. A part (C) in FIG. 5 is a diagram showing the comparison between the filling rates of the developer in the second transport path 54b in a case where the amount of developer is large and in a case where the amount of developer is small. In addition, the horizontal axis in the parts (B) and (C) in FIG. 5 corresponds to a position in a longitudinal direction of the second transport path 54b in the part (A) in FIG. 5. Here, the filling rate means the proportion of the developer to the space (unit volume) of a developer flow path.

As shown in the part (B) in FIG. 5, in the second transport path 54b, the transport speed of the developer is low in the low-speed transport region LS in which the narrow-pitch helical blade 65 of the second agitating and transport member 58b is arranged. In addition, as shown in the part (C) in FIG. 5, the difference between the filling rates of the developer in the low-speed transport region LS in the state in which the amount of developer is large and in the state in which the amount of developer is small is large. That is, the installation of the volume detection sensor 68 in the low-speed transport region LS makes it possible to reduce the transport speed of the developer and to make the change in volume more pronounced depending on the state of the amount of developer. Therefore, it is possible to improve the detection accuracy of the volume detection sensor 68.

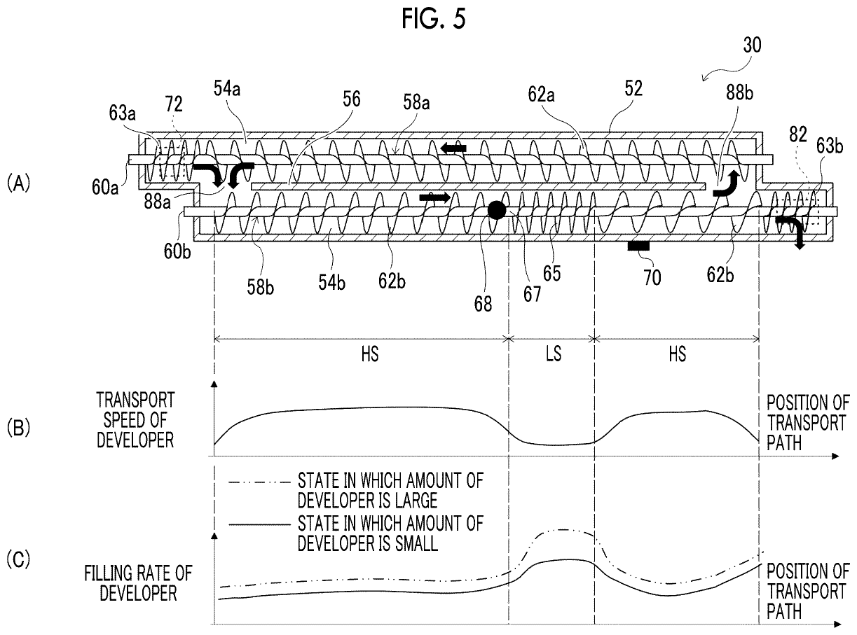

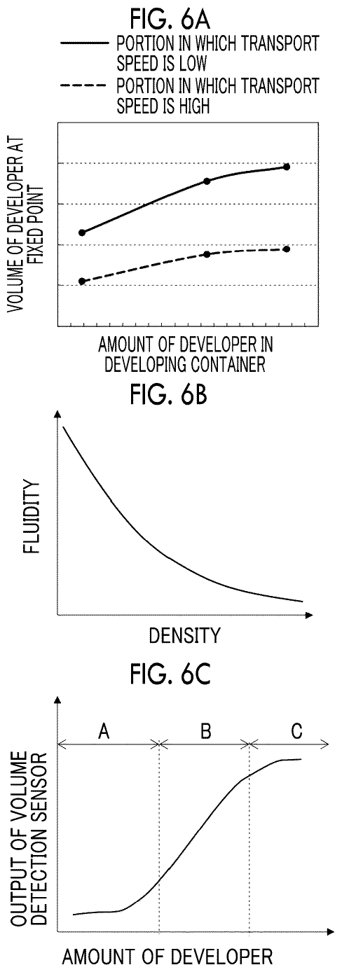

FIG. 6A is a diagram showing a relationship between the amount of developer in the developing container 52 and the volumes detected at fixed points in a portion in which the transport speed of the developer is low and in a portion in which the transport speed of the developer is high. FIG. 6B is a diagram showing a relationship between the density and fluidity of the developer.

As shown in FIG. 6A, in a case where the volumes of the developer at the fixed points are compared using the same amount of developer, the amount of change in the volume of the developer in the portion in which the transport speed of the developer is low can be larger than the amount of change in the volume of the developer in the portion in which the transport speed of the developer is high. In addition, since the transport speed is low in the switching portion 67, the volume of the developer in the switching portion 67 is larger than the volume of the developer on the upstream side of the switching portion 67. Further, as the volume increases, the density of the developer also increases. Therefore, as shown in FIG. 6B, the fluidity decreases, and the volume further increases.

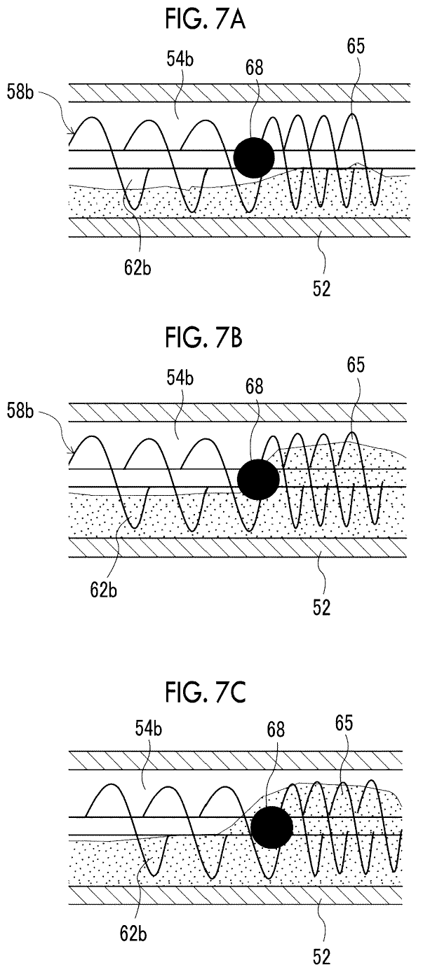

FIG. 6C is a diagram showing a relationship between the amount of developer and the output of the volume detection sensor 68 in a case where the volume detection sensor 68 is installed in the switching portion 67. A to C of FIG. 6C show the output results of the volume detection sensor 68 in a case where the amounts of developer are as shown in FIGS. 7A to 7C, respectively. As shown in A of FIG. 6C and FIG. 7A, in a state in which the amount of developer is small, the output value of the volume detection sensor 68 is small, and the amount of change in the volume is small. In addition, as shown in C of FIG. 6C and FIG. 7C, in a state in which the amount of developer is large, the volume changes from the upstream side of the volume detection sensor 68. Therefore, the output value of the volume detection sensor 68 is large, and the amount of change in the volume is small. Further, as shown in B of FIG. 6C and FIG. 7B, in a case where the amount of developer changes from the vicinity of the volume detection sensor 68, the amount of change in the volume is large.

As described above, the volume detection sensor 68 is provided in the region in which the amount of change in the volume detected by the volume detection sensor 68 is large in a state in which the amount of developer in the developing container 52 is large and in a state in which the amount of developer in the developing container 52 is small. Therefore, the change in the volume can be more pronounced in a state in which the amount of developer is large and in a state in which the amount of developer is small. That is, it is possible to improve the detection accuracy of the volume detection sensor 68.

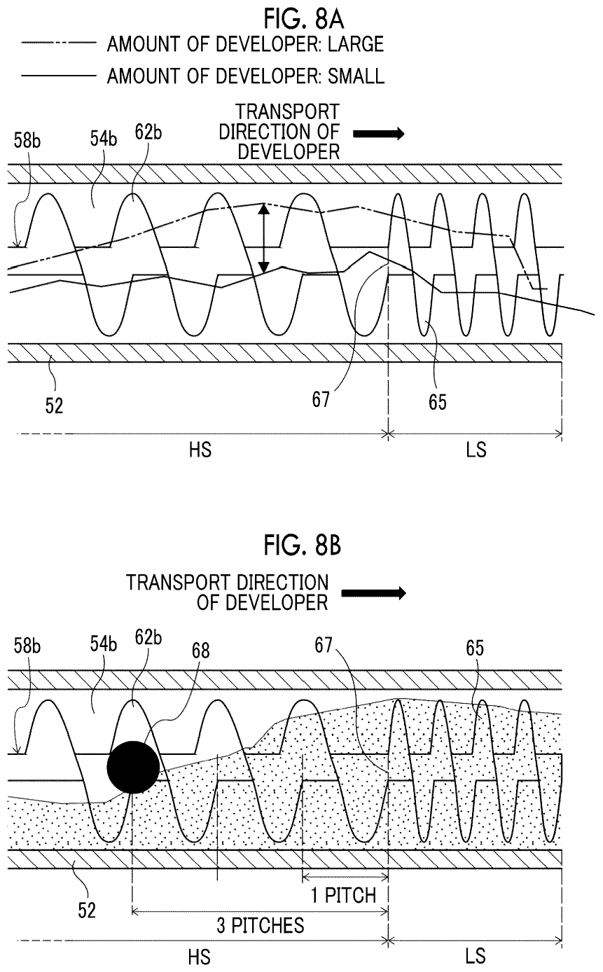

FIG. 8A is a diagram showing the change in the volume in the high-speed transport region HS and the low-speed transport region LS of the second transport path 54b and is a diagram showing the comparison between the state in which the amount of developer is large and the state in which the amount of developer is small. FIG. 8B is a diagram showing the installation range of the volume detection sensor 68 in the longitudinal direction.

As shown in FIG. 8A, the volume of the developer is at the highest level between the switching portion 67 and the position that is three pitches upstream of the switching portion 67. Then, in a range from the position that is three pitches upstream of the switching portion 67 to the most downstream portion of the low-speed transport region LS, the difference between the volumes in the state in which the amount of developer is large and in the state in which the amount of developer is small is large. Therefore, for example, as shown in FIG. 8B, it is preferable to provide the volume detection sensor 68 between the position that is three pitches upstream of the switching portion 67 and the most downstream portion of the low-speed transport region LS. As a result, the change in the volume can be more pronounced in the state in which the amount of developer is large and in the state in which the amount of developer is small. That is, it is possible to improve the detection accuracy of the volume detection sensor 68.

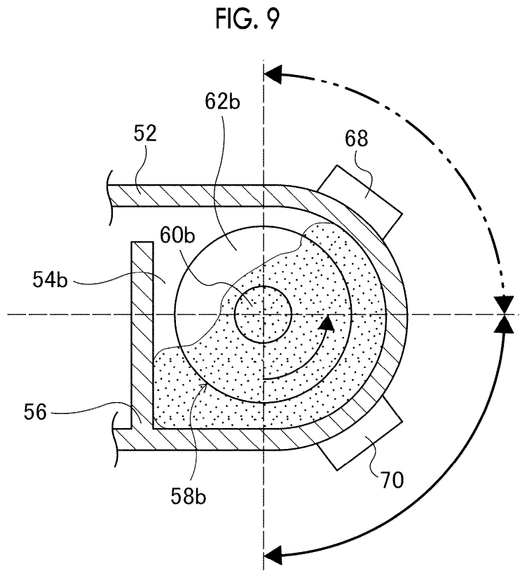

FIG. 9 shows the installation range of the volume detection sensor 68 and the concentration sensor 70 in a circumferential direction. As represented by a two-dot chain line in FIG. 9, the volume detection sensor 68 is provided on the second transport path 54b of the developing container 52, for example, in a direction from 12 o'clock to 3 o'clock above the center of the rotation shaft 60b of the second agitating and transport member 58b in a direction of gravity and on the upstream side in the rotation direction of the rotation shaft 60b.

In addition, the concentration sensor 70 is installed in a region other than the low-speed transport region LS of the second transport path 54b, for example, in the high-speed transport region HS on the downstream side of the low-speed transport region LS in the transport direction of the developer. As represented by a solid line in FIG. 9, the concentration sensor 70 is provided on the second transport path 54b of the developing container 52, for example, in a direction from 3 o'clock to 6 o'clock below the center of the rotation shaft 60b of the second agitating and transport member 58b in the direction of gravity and on the downstream side in the rotation direction of the rotation shaft 60b. The concentration sensor 70 detects the amount of carrier included in the developer to detect the concentration of the toner.

Then, in the developing device 30, a processor corrects the detection result of the volume detection sensor 68 according to the concentration of the toner detected by the concentration sensor 70, and the developer supply unit 74 supplies the developer into the developing container 52 or the developer discharge unit 86 discharges the developer in the developing container 52.

Next, modification examples will be described in detail.

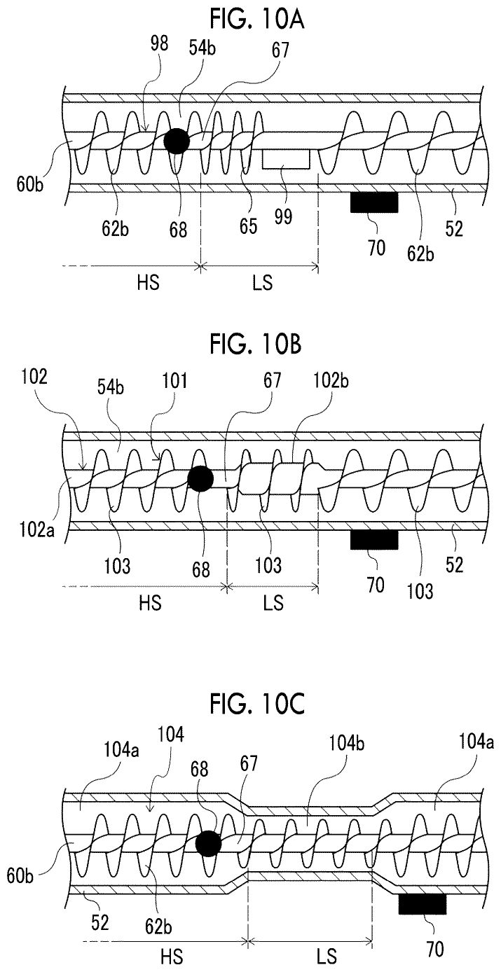

FIG. 10A shows Modification Example 1. In the present modification example, a second agitating and transport member 98 having a shape different from the shape of the second agitating and transport member 58b is used.

The second agitating and transport member 98 according to Modification Example 1 includes the rotation shaft 60b, the helical blade 62b that is formed in a helical shape in the axial direction with respect to the rotation shaft 60b, the helical blade 65 having a narrower pitch than the helical blade 62b, a flat blade 99 that is formed in a radial direction along the axial direction of the rotation shaft 60b, and the helical blade 63b having a narrower pitch than the helical blade 62b. The flat blade 99 is provided on the downstream side of the helical blade 65 of the second agitating and transport member 98 in the transport direction of the developer. Then, in the second transport path 54b, the helical blade 62b is arranged in the high-speed transport region HS, and the helical blade 65 having a narrower pitch than the helical blade 62b and the flat blade 99 are arranged in the low-speed transport region LS.

Since the flat blade 99 is arranged in the low-speed transport region LS, it is possible to reduce the transport force of the developer in the low-speed transport region LS, and the transport speed of the developer in the low-speed transport region LS can be lower than the transport speed of the developer in the high-speed transport region HS. That is, in the present modification example, similarly to the developing device 30, the volume detection sensor 68 is provided in the range set in advance from the switching portion 67 that switches from the high-speed transport region HS to the low-speed transport region LS to the upstream side in the transport direction, or in the low-speed transport region LS. Therefore, the change in the volume of developer can be more pronounced in the state in which the amount of developer is large and in the state in which the amount of developer is small, and the detection accuracy of the volume detection sensor 68 can be improved.

FIG. 10B shows Modification Example 2. In the present modification example, a second agitating and transport member 101 having a shape different from the shape of the second agitating and transport member 58b is used.

The second agitating and transport member 101 according to Modification Example 2 includes a rotation shaft 102 composed of a rotation shaft 102a and a rotation shaft 102b that is thicker and has a larger shaft diameter than the rotation shaft 102a and a helical blade 103 that is formed in a helical shape in an axial direction with respect to the rotation shaft 102. Then, in the second transport path 54b, the rotation shaft 102a and the helical blade 103 formed in a helical shape with respect to the rotation shaft 102a are arranged in the high-speed transport region HS, and the rotation shaft 102b and the helical blade 103 formed in a helical shape with respect to the rotation shaft 102b are arranged in the low-speed transport region LS. That is, the shaft diameter of the second agitating and transport member 101 in the low-speed transport region LS is larger than the shaft diameter of the second agitating and transport member 101 in the high-speed transport region HS. Therefore, a passage width of the developer in the low-speed transport region LS is narrower than a passage width of the developer in the high-speed transport region HS.

As described above, since the passage width of the developer in the low-speed transport region LS is narrower than the passage width of the developer in the high-speed transport region HS, it is possible to reduce the cross section of the transport path. Therefore, the transport force of the developer in the low-speed transport region LS can be reduced, and the transport speed of the developer in the low-speed transport region LS can be lower than the transport speed of the developer in the high-speed transport region HS. That is, in the present modification example, similarly to the developing device 30, the volume detection sensor 68 is provided in the range set in advance from the switching portion 67 that switches from the high-speed transport region HS to the low-speed transport region LS to the upstream side in the transport direction, or in the low-speed transport region LS. Therefore, the change in the volume of developer can be more pronounced in the state in which the amount of developer is large and in the state in which the amount of developer is small, and the detection accuracy of the volume detection sensor 68 can be improved.

FIG. 10C shows Modification Example 3. In the present modification example, a second transport path 104 having a shape different from the shape of the second transport path 54b is used.

The second transport path 104 according to Modification Example 3 is composed of a transport path 104a and a transport path 104b having a smaller inner diameter than the transport path 104a. Then, the transport path 104a having a large inner diameter is arranged in the high-speed transport region HS, and the transport path 104b having a small inner diameter is arranged in the low-speed transport region LS. That is, the inner diameter of the second transport path 104 in the low-speed transport region LS is smaller than the inner diameter of the second transport path 104 in the high-speed transport region HS. Therefore, a passage width of the developer in the low-speed transport region LS is narrower than a passage width of the developer in the high-speed transport region HS.

As described above, since the passage width of the developer in the low-speed transport region LS is narrower than the passage width of the developer in the high-speed transport region HS, it is possible to reduce the cross section of the transport path. Therefore, the transport force of the developer in the low-speed transport region LS can be reduced, and the transport speed of the developer in the low-speed transport region LS can be lower than the transport speed of the developer in the high-speed transport region HS. That is, in the present modification example, similarly to the developing device 30, the volume detection sensor 68 is provided in the range set in advance from the switching portion 67 that switches from the high-speed transport region HS to the low-speed transport region LS to the upstream side in the transport direction, or in the low-speed transport region LS. Therefore, the change in the volume of developer can be more pronounced in the state in which the amount of developer is large and in the state in which the amount of developer is small, and the detection accuracy of the volume detection sensor 68 can be improved.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

In addition, the operations of the processor in the above-described exemplary embodiments may not only be performed by one processor, but may also be performed by the cooperation of a plurality of processors at physically separate locations. Further, the order of the operations of the processor is not limited to the order described in each of the exemplary embodiments and may be appropriately changed.

### MODIFICATION EXAMPLES

The exemplary embodiment of the present disclosure has been specifically described above. However, the present disclosure is not limited to the above-described exemplary embodiment and can be modified in various manners without departing from the gist of the present disclosure.

In the above-described exemplary embodiment, the case where the developing device 30 includes two transport paths has been described. However, the present disclosure is not limited to this and can be similarly applied even in a case where the number of transport paths is one or three or more.

In addition, in the above-described exemplary embodiment, the case where the image forming units of four colors of yellow, magenta, cyan, and black are provided has been described. However, the present disclosure is not limited to this and can be similarly applied even in a case where image forming units of four or more colors are provided or a black and white (monochrome) image forming unit is provided.

### Supplementary Note

Hereinafter, a supplementary note of the aspects of the present disclosure will be described.

(((1)))

A developing device comprising:
a developing container that accommodates a developer;
an agitating and transport member that includes a rotation shaft and a helical blade formed in a helical shape in an axial direction with respect to the rotation shaft and that transports the developer in the developing container while agitating the developer;
a transport path that accommodates the agitating and transport member and includes a high-speed transport region in which the developer is transported at a high speed and a low-speed transport region that is arranged on a downstream side of the high-speed transport region in a transport direction of the developer and in which the developer is transported at a lower speed than in the high-speed transport region; and
a volume detection unit that is installed within a range set in advance from a switching portion that switches from the high-speed transport region to the low-speed transport region to an upstream side in the transport direction or in the low-speed transport region and that detects a volume of the developer in the transport path.
   (((2)))

The developing device according to (((1))),
wherein the agitating and transport member includes a first helical blade and a second helical blade having a narrower pitch than the first helical blade,
the first helical blade is arranged in the high-speed transport region, and
the second helical blade is arranged in the low-speed transport region.
   (((3)))

The developing device according to (((1))),
wherein the agitating and transport member further includes a flat blade that is formed in a radial direction along the axial direction with respect to the rotation shaft,
the helical blade is arranged in the high-speed transport region, and
the flat blade is arranged in the low-speed transport region.
   (((4)))

The developing device according to (((1))),
wherein a passage width of the developer in the low-speed transport region is narrower than a passage width of the developer in the high-speed transport region.
   (((5)))

The developing device according to (((4))),
wherein an inner diameter of the transport path in the low-speed transport region is smaller than an inner diameter of the transport path in the high-speed transport region.
   (((6)))

The developing device according to (((4))),
wherein a shaft diameter of the agitating and transport member in the low-speed transport region is larger than a shaft diameter of the agitating and transport member in the high-speed transport region.
   (((7)))

The developing device according to any one of (((1))) to (((6))),
wherein the volume detection unit is provided on the transport path above a center of the rotation shaft of the agitating and transport member in a direction of gravity and on an upstream side in a rotation direction of the rotation shaft.
   (((8)))

The developing device according to any one of (((1))) to (((7))),
wherein the volume detection unit is installed within a range from the switching portion to a position that is upstream by a distance corresponding to three pitches of the helical blade in the high-speed transport region, or in the low-speed transport region.
   (((9)))

The developing device according to (((1))),
wherein the developing container includes a first transport path for supplying the developer to a developing roller and a second transport path adjacent to the first transport path, and
the transport path is the second transport path.
   (((10)))

The developing device according to any one of (((1))) to (((9))), further comprising:
a concentration detection unit that is installed in a region other than the low-speed transport region in the transport path,
wherein the developer is a two-component developer including a toner and a carrier, and
the concentration detection unit detects an amount of the carrier included in the developer to detect a concentration of the toner.
   (((11)))

The developing device according to (((10))), further comprising:
a processor configured to:
correct a detection result of the volume detection unit according to the concentration of the toner detected by the concentration detection unit and supply the developer into the developing container or discharge the developer in the developing container.
   (((12)))

An image forming apparatus comprising:
an image carrier that holds an electrostatic latent image; and
a developing device that develops the electrostatic latent image held on the image carrier,
wherein the developing device includes
a developing roller,
a developing container that accommodates a developer to be supplied to the developing roller,
an agitating and transport member that includes a rotation shaft and a helical blade formed in a helical shape in an axial direction with respect to the rotation shaft and that transports the developer in the developing container while agitating the developer,
a transport path that accommodates the agitating and transport member and includes a high-speed transport region in which the developer is transported at a high speed and a low-speed transport region that is arranged on a downstream side of the high-speed transport region in a transport direction of the developer and in which the developer is transported at a lower speed than in the high-speed transport region, and
a volume detection unit that is installed within a range set in advance from a switching portion that switches from the high-speed transport region to the low-speed transport region to an upstream side in the transport direction or in the low-speed transport region and that detects a volume of the developer in the transport path.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a developing container that accommodates a developer;
an agitating and transport member that includes a rotation shaft and a helical blade formed in a helical shape in an axial direction with respect to the rotation shaft and that transports the developer in the developing container while agitating the developer;
a transport path that accommodates the agitating and transport member and includes a high-speed transport region in which the developer is transported at a high speed and a low-speed transport region that is arranged on a downstream side of the high-speed transport region in a transport direction of the developer and in which the developer is transported at a lower speed than in the high-speed transport region; and
a volume detection unit that is installed within a range set in advance from a switching portion that switches from the high-speed transport region to the low-speed transport region to an upstream side in the transport direction or in the low-speed transport region and that detects a volume of the developer in the transport path.

2. The developing device according to claim 1,
wherein the agitating and transport member includes a first helical blade and a second helical blade having a narrower pitch than the first helical blade,
the first helical blade is arranged in the high-speed transport region, and
the second helical blade is arranged in the low-speed transport region.

3. The developing device according to claim 1,
wherein the agitating and transport member further includes a flat blade that is formed in a radial direction along the axial direction with respect to the rotation shaft,
the helical blade is arranged in the high-speed transport region, and
the flat blade is arranged in the low-speed transport region.

4. The developing device according to claim 1,
wherein a passage width of the developer in the low-speed transport region is narrower than a passage width of the developer in the high-speed transport region.

5. The developing device according to claim 4,
wherein an inner diameter of the transport path in the low-speed transport region is smaller than an inner diameter of the transport path in the high-speed transport region.

6. The developing device according to claim 4,
wherein a shaft diameter of the agitating and transport member in the low-speed transport region is larger than a shaft diameter of the agitating and transport member in the high-speed transport region.

7. The developing device according to claim 1,
wherein the volume detection unit is provided on the transport path above a center of the rotation shaft of the agitating and transport member in a direction of gravity and on an upstream side in a rotation direction of the rotation shaft.

8. The developing device according to claim 1,
wherein the volume detection unit is installed within a range from the switching portion to a position that is upstream by a distance corresponding to three pitches of the helical blade in the high-speed transport region, or in the low-speed transport region.

9. The developing device according to claim 1,
wherein the developing container includes a first transport path for supplying the developer to a developing roller and a second transport path adjacent to the first transport path, and
the transport path is the second transport path.

10. The developing device according to claim 1, further comprising:
a concentration detection unit that is installed in a region other than the low-speed transport region in the transport path,
wherein the developer is a two-component developer including a toner and a carrier, and
the concentration detection unit detects an amount of the carrier included in the developer to detect a concentration of the toner.

11. The developing device according to claim 10, further comprising:
a processor configured to:
correct a detection result of the volume detection unit according to the concentration of the toner detected by the concentration detection unit and supply the developer into the developing container or discharge the developer in the developing container.

12. An image forming apparatus comprising:
an image carrier that holds an electrostatic latent image; and
a developing device that develops the electrostatic latent image held on the image carrier,
wherein the developing device includes
a developing roller,
a developing container that accommodates a developer to be supplied to the developing roller,
an agitating and transport member that includes a rotation shaft and a helical blade formed in a helical shape in an axial direction with respect to the rotation shaft and that transports the developer in the developing container while agitating the developer,
a transport path that accommodates the agitating and transport member and includes a high-speed transport region in which the developer is transported at a high speed and a low-speed transport region that is arranged on a downstream side of the high-speed transport region in a transport direction of the developer and in which the developer is transported at a lower speed than in the high-speed transport region, and
a volume detection unit that is installed within a range set in advance from a switching portion that switches from the high-speed transport region to the low-speed transport region to an upstream side in the transport direction or in the low-speed transport region and that detects a volume of the developer in the transport path.
